(19) United States
(12) Patent Application Publication
(10) Pub. No.: US 2025/0298593 A1
(43) Pub. Date: Sep. 25, 2025

(54) RETRIEVAL AUGMENTED CODE TRANSLATION

(71) Applicant: INTERNATIONAL BUSINESS MACHINES CORPORATION, Armonk, NY (US)

(72) Inventors: Rahul Krishna Prasad, White Plains, NY (US); Rangeet Pan, White Plains, NY (US); Vijay Arya, Gurgaon (IN); Yogish Sabharwal, Gurgaon (IN); Saurabh Sinha, Danbury, CT (US); Boris Sobolev, New York, NY (US); Venkata Nagaraju Pavuluri, New Rochelle, NY (US); Maja Vukovic, New York, NY (US)

(21) Appl. No.: 18/615,600

(22) Filed: Mar. 25, 2024

(51) Int. Cl. G06F 8/51

(52) U.S. Cl. CPC G06F 8/51

(57) ABSTRACT

Methods and systems for code translation include generating metadata for input program code, including an intermediate representation of the input program code. A database of stored code samples is searched to select an example code sample based on similarity between metadata of the input program code and stored metadata of the stored code samples. A prompt is generated that includes the input program code, the example code sample, and a translation of the example code sample. The prompt is applied to a pre-trained language model to generate a translation of the input program code in a target programming language.

### BACKGROUND

The present invention generally relates to automated code translation and, more particularly, to code translation by machine learning models.

Code translation is the process of converting program source code from one programming language into another. For example, code translation may be performed to modernize a given application that was written in a programming language that is no longer supported. Code translation may also be performed to migrate an application from one environment to another, such as when moving to a cloud environment.

However, code translation is a challenging task that needs an understanding of both syntax and semantics. Existing approaches to automatic code translation fail to provide accurate translations. For example, off-the-shelf language models cannot perform adequately on code translation tasks, and even fine-tuned models provide inaccurate results.

### SUMMARY

A method for code translation includes generating metadata for input program code, including an intermediate representation of the input program code. A database of stored code samples is searched to select an example code sample based on similarity between metadata of the input program code and stored metadata of the stored code samples. A prompt is generated that includes the input program code, the example code sample, and a translation of the example code sample. The prompt is applied to a pre-trained language model to generate a translation of the input program code in a target programming language.

A system or code translation includes a hardware processor and a memory that stores a computer program. When executed by the hardware processor, the computer program causes the hardware processor to generate metadata for input program code, including an intermediate representation of the input program code, to search a database of stored code samples to select an example code sample based on similarity between metadata of the input program code and stored metadata of the stored code samples, to generate a prompt that includes the input program code, the example code sample, and a translation of the example code sample, and to apply the prompt to a pre-trained language model to generate a translation of the input program code in a target programming language.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a diagram illustrating the translation of a program code that is written in a first programming language into a second programming language, in accordance with an embodiment of the present invention;

FIG. 2 is a block/flow diagram of a method for performing code translation using a database of code samples, in accordance with an embodiment of the present invention;

FIG. 3 is a block/flow diagram of a method of indexing program code to store metadata representing the program code in a database, in accordance with an embodiment of the present invention;

FIG. 4 is a block/flow diagram of a method of searching the database for indexed program code that matches an input program code and generating a prompt based on the results, in accordance with an embodiment of the present invention;

FIG. 5 is a block diagram of a method/system for performing retrieval-augmented code translation, in accordance with an embodiment of the present invention; and

FIG. 6 is a block diagram of a computer system that can perform automated code translation, in accordance with an embodiment of the present invention.

### DETAILED DESCRIPTION

Accurate code translation can be performed using a machine learning-based pipeline that makes use of a database of associations between particular code examples and intermediate representations thereof. The database may be populated with pairs of such associations at different granularities, and may be searched when a code translation task is performed. Context information may further be stored while translating code block-to-block. This approach is flexible with respect to the language model, programming language, and type of intermediate representation that is used.

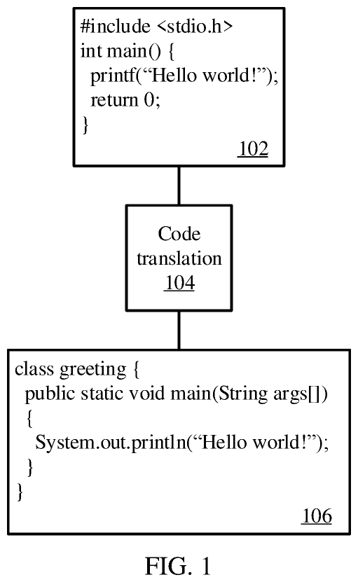

Referring now to FIG. 1, a diagram illustrating code translation is shown. An input program 102, written in a first programming language, is provided to code translation 104. The code translation 104 generates an output program 106 that performs the same function as the input program 102, but written in a second programming language. In the present example, the input program 102 outputs the text “Hello world!” and is written in C. The output program 106 outputs the same text, but is written in JAVA®.

It should be understood that the first programming language and the second programming language may be completely different languages, or may be different versions of a same language. For example, a later version of a given language, such as C++, may share a large amount of syntax with a previous version, but may have features that are unavailable in the previous version. Thus the code translation 104 may translate from an older version to a newer version, or may translate from a newer version to an older version. In another example, the version of the language may be the same, but available libraries may differ between the input program 102 and the output program 106. In such circumstances, code translation 104 may replicate features from the library so that functionality may be preserved in the output program 106.

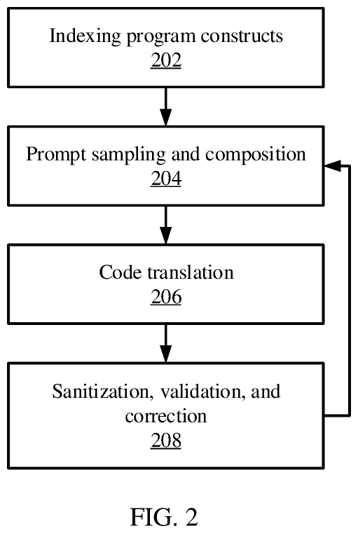

Referring now to FIG. 2, a method of performing code translation is shown. Block 202 indexes program constructs based on a set of samples from a source programming language. These constructs are stored in a database for later use. Block 204 then accepts source code to be translated and searches the database to identify a prompt that is suitable for translating from the source language to the target language for the input. Using this prompt, block 206 performs code translation for input code in the source language to generate output code in the target language. Block 208 performs sanitization, validation, and iterative correction of the output of the language model to ensure an accurate translation.

Indexing 202 stores metadata about the source language sample code at different granularities. Granularity represents the amount of code that is considered at once. For example, the granularity may be a single line of code, may be a code block (e.g., an entire loop), or may include an entire function or data structure definition. The source language sample code may be divided using Hammock decomposition to generate source code slices at different granularities, with each slice of code being stored in the database with its respective intermediate representation and other metadata. In this fashion, more granular examples can be provided as in-context examples to increase translation accuracy.

As used herein, an intermediate representation of a given computer program's source code is a form that standardizes the program semantics, for example by converting variable names to a standard set of names and otherwise regularizing the structure of the program code. In some cases, programs written in separate languages may have identical intermediate representations. The programs may furthermore differ semantically but may have identical functions, generating identical intermediate representations.

An abstract syntax tree may also be associated with each slice of code. The intermediate representation and the abstract syntax tree are two different ways of representing the code's functionality in a language-agnostic fashion, capturing the functionality of the code in a way that does not depend on the particular syntax of the source programming language. Given a slice of code, indexing 202 stores metadata along with the slice, which may include the intermediate representation of the code, the program constructs that are contained in the code, and an abstract syntax tree of the code. The metadata for the code may further include an embedding of the intermediate representation in an appropriate latent space, an embedding of the abstract syntax tree, as well as a sparse encoding of the code slice. The sparse encoding may include, for example, a sparse vector of terms in the source language, based on frequency of occurrence of those terms in the code slice (e.g., using term frequency-inverse document frequency (TF-IDF)).

Thus the index for a given fragment of code from an input sample may include a copy of the code, an intermediate representation of the code, and an embedding vector that can be used for retrieval by downstream tasks. The entire sample may then be stored in association with a respective intermediate representation, the abstract syntax tree, and an embedding vector.

Contextual information may further be stored in the database. For example, if a given method accesses a variable that is defined outside the method body, then that information should be preserved for the translation. Contextual information can include variable types, method signature information, and other global information given the scope of the code fragment being translated.

Prompt composition in block 204 uses a search to find slices of program in the target language that best map a snippet from an input program to be translated. Rather than finding an identical, or near-identical, paired sample of the entire program, the intermediate representation is used to extract minimal program slices that best match slices from the source program to induce an in-context learning. The intermediate representation, owing to its standardization of the program semantics, can serve as an approximate projection to identify similar program samples.

The translation 206 of code fragments may be performed in an order that is determined based on the type of code, by submitting respective prompts to a pre-trained language model. For example, non-method-related code may be translated first, such as the definition of data structures. Methods may then be translated one at a time. For scripting-like programming languages, a different granularity level may be selected based on the size of the code. Sanitization, validation, and correction 208 may be performed on the output of the translation 206 to ensure correctness of the translated code.

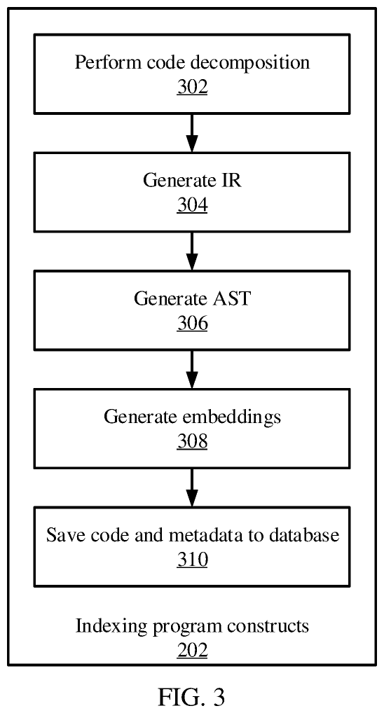

Referring now to FIG. 3, additional detail on the indexing 202 is shown. A set of source code samples are processed and indexed, and may include source code relating to various functionalities and may be written in multiple different programming languages. The source code samples are divided into slices with code decomposition 302, which may for example be implemented as Hammock code decomposition. Hammock decomposition uses a hammock graph, over which graph traversal is performed. A hammock region includes all the nodes and edges in the graph that can be reached from an entry point and that reach an exit point without passing through the entry or exist again. Each block of the graph may be traversed in a depth-first search to identify the blocks. Blocks of differing granularity may be selected, resulting in code slices having differing lengths.

An intermediate representation (IR) is generated for each code slice in block 304. As noted above, the intermediate representation is a language-agnostic representation of the functionality of the code slice. Following the example of FIG. 1, both the input program 102 and the output program 106 will have the exact same intermediate representation. Block 306 similarly generates an abstract syntax tree (AST) for each of the code slices. An abstract syntax tree is a different type of representation of the code slice, where the functionality is presented in the form of a tree.

Block 308 formed embeddings of the intermediate representation and the abstract syntax tree, using any appropriate embedding scheme to generate respective vectors in a latent space. Block 308 may furthermore generate a sparse encoding of the code slice itself, generating a sparse encoding vector that captures statistics about the terms used in the code slice, such as by TF-IDF.

Block 310 stores the code slice, along with the metadata described above, in a database. As will be described in greater detail below, the metadata may be used to search the database to identify code slices that are similar to an input code slice.

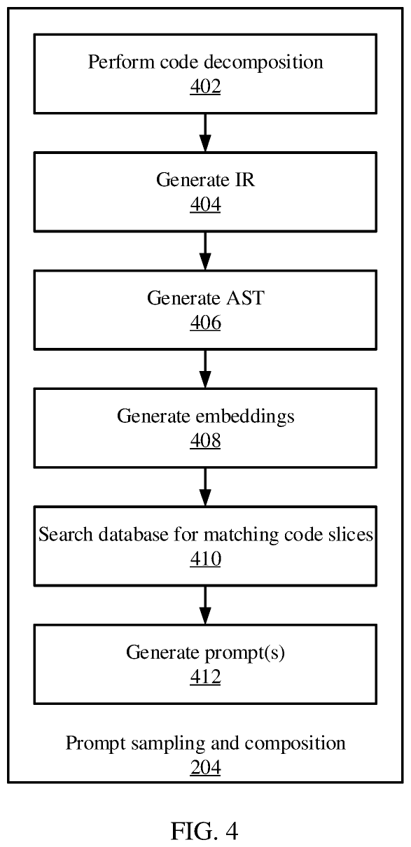

Referring now to FIG. 4, additional detail on prompt sampling and composition 204 is shown. New program code is received, with a request to translate the new program code from a source language into a target language. As with the indexing of the source samples in block 202, this new program code is similarly processed, starting with code decomposition 402 to break it into input code slices. Block 404 generates intermediate representations for the input code slices, block 406 generates abstract syntax trees for the input code slices, and block 408 generates embeddings for the input code slices.

This information is used to search the database for matching code slices, for example using one or more similarity metrics to identify the stored code slices that are most similar to the input code slices. As will be described in greater detail below, the search can consider similarity using multiple different metrics, for example considering each of the different kinds of metadata. One or more stored code slices are selected from the database for each of the input code slices.

Block 412 generates translation prompts based on the input code slices and the respective selected code slices. For example, a prompt may begin with a general directive, in natural language, that provides instructions to a language model. An exemplary general directive might read, “Generate a direct translation of the below <SOURCE> program to <TARGET>, using the example(s) below:” where <SOURCE> is the programming language of the new program code and there <TARGET> is the programming language that the new program code is to be translated into.

The prompt may further include the selected code slices that were output by block 410. This portion of the prompt may use the stored code slice and the corresponding target language translation for the selected code slice, so that the language model has examples of associations between code and target language translations. The stored code slices may be modified before inclusion in the prompt, for example changing variable names and function names to generic alternatives.

The prompt may further include the input code slice corresponding to the selected code slices. Combining the directive, the examples, and the input code slice into a single prompt makes it possible to provide additional information to a pretrained language model, thereby improving the quality of its translation outputs. Code translation 206 may therefore be performed simply by executing the prompt on the language model and reviewing the output.

The step of sanitization, validation, and correction 208 may be performed on the translated output to ensure that it meets certain requirements. For example, static and/or dynamic analysis may be performed to identify grammatical and syntax errors, runtime errors may be identified, and test cases may be run to ensure proper functioning of the translated code. If there are errors, the prompt may be modified with different examples to refine the output code.

As noted above, the search of block 410 may search the database across multiple different similarity metrics. For example, the code slices themselves may be compared according to a Jaccard similarity, the abstract syntax trees may be compared according to a tree edit distance, the embedding vectors of the intermediate representation may be compared according to a cosine similarity, and the sparse encoding of terms in the code slice may be compared according to a BM25 similarity. Each of these similarity metrics will generate different respective similarity scores between a new code slice and the stored code slices in the database.

The scores may then be re-ranked to improve diversity among the selected code slices. For example, this diversity ranking may lower the rank of a stored code sample that is similar to a higher-ranked stored code slice, thereby discouraging multiple highly similar stored code slices from being selected for a given input code slice. The re-ranking may include, for example, maximal marginal re-ranking, but any appropriate re-ranking scheme may be used instead.

Ranking fusion may further be applied to combine the ranks based on the different similarity metrics into a single consolidated list for each stored code slice. For example, the ranks according to the different similarity metrics may be expressed as r₁, . . . , r₄. Reciprocal rank fusion can be used to combine the ranks for a code slice Rᵢ, for example with a scoring function:

$${Score}_{∀ i ∈ [ 1 , … , n ]} {\sum }_{j = 1}^{m} \frac{{w}_{j}}{k + rank ( i , {r}_{j} )}$$

where n=4 corresponds to each of the ranks, m corresponds to the number of samples in the database, and k≥1 is a rank constant that determines how much influence documents in individual result sets have over the final ranked result set. A fused ranking of the code slices may be expressed as:

[symbol]

=argsort(score(Rᵢ))

which sorts items in descending order based on their overall scores and gives a single ranking that combines the results of the multiple similarity metrics.

The reciprocal rank fusion computes the reciprocal of each item's rank in each individual ranking, giving higher scores to items that appear near the top of the rankings and lower scores to those that appear further down.

Based on these rankings, and on the similarity scores themselves, a set of stored code slices are selected for use in the prompt. The selection may make use of any appropriate recommendation method for example using a k nearest neighbor approach or using a reinforcement learning approach. The number of stored code slices to select is a hyperparameter that may be specified by the user and that may be constrained by practical limitations of the language model, for example limiting prompt length.

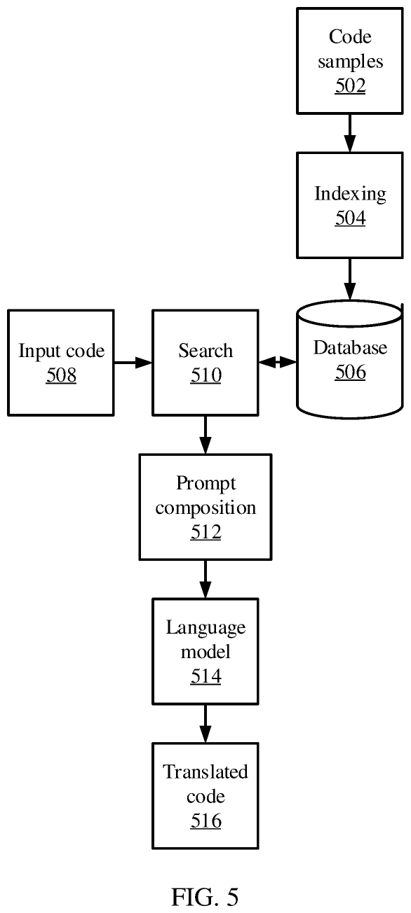

Referring now to FIG. 5, an overview of code translation is shown. Code samples 502 are indexed 504 as described above and are stored in a database 506, along with associated metadata. Input code 508, written in a source programming language, is used to search 510 the database 506, selecting stored code slices that match input code slices. Prompt composition 512 combines the input code and the selected code slices to form a prompt, which is applied as input to a pretrained language model 514. The prompt instructs the language model to translate the input code 508 from the source programming language to a target programming language, generating translated code 516. Once the translated code 516 has been sanitized and validated, it may be executed or compiled as needed.

It is specifically contemplated that the pretrained language model 514 may be any appropriate large language model that has been trained to work on programming languages. The pretrained language model 514 may be designed specifically to perform code translation, but more general language models may be used as well. The language model 514 may be owned and operated by the same entity that controls the database 506, or it may be operated by an external entity that provides an accessible interface to third parties that accepts the prompt and that returns the translated code.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

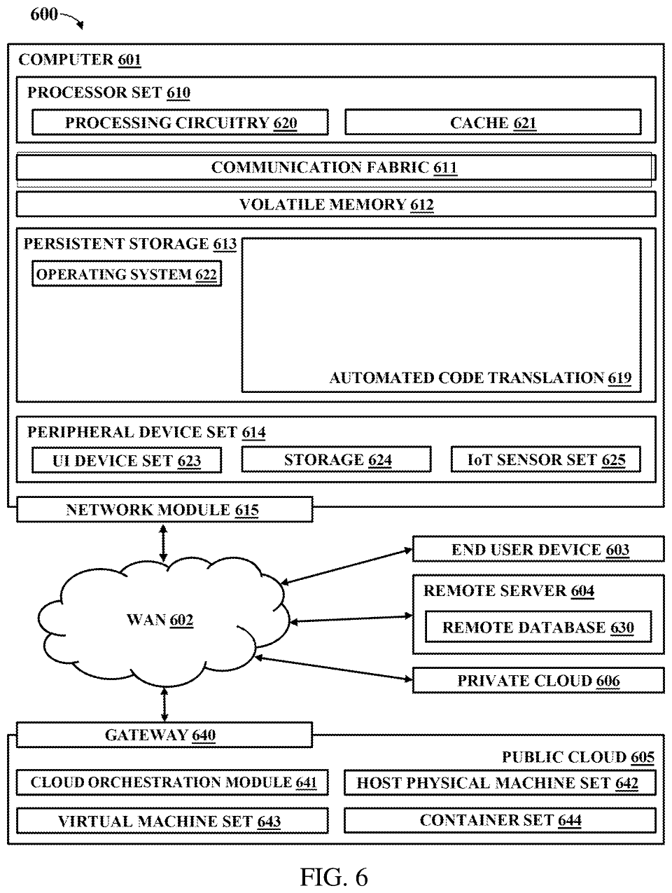

Referring now to FIG. 6, a block diagram of a computing environment is shown. Computing environment 600 contains an example of an environment for the execution of at least some of the computer code involved in performing the inventive methods, such as automated code translation 619. In addition to block 619, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 619, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible.

Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 619 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel. The code included in block 619 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices.

Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of retrieval augmented code translation (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method for code translation, comprising:
generating metadata for input program code, including an intermediate representation of the input program code;
searching a database of stored code samples to select an example code sample based on similarity between metadata of the input program code and stored metadata of the stored code samples;
generating a prompt that includes the input program code, the example code sample, and a translation of the example code sample; and
applying the prompt to a pre-trained language model to generate a translation of the input program code in a target programming language.

2. The method of claim 1, wherein generating the metadata further includes an abstract syntax tree of the input program code.

3. The method of claim 1, wherein generating the metadata further includes an embedding of the intermediate representation and a sparse encoding of the input program code.

4. The method of claim 1, wherein searching the database includes calculating a respective similarity score for each of a plurality of metadata types of the input program code as compared to corresponding metadata of stored code samples.

5. The method of claim 4, wherein searching the database includes performing a diversity re-ranking based on the similarity scores for the stored code samples to promote diversity between the stored code samples.

6. The method of claim 5, wherein searching the database comprises fusing rankings for the plurality of metadata types into a single rank score for each stored code sample.

7. The method of claim 1, further comprising performing a hammock decomposition on an input source into a plurality of program codes, of which the input program code is one, wherein generating metadata, searching the database, generating the prompt, and applying the prompt is performed for each of the program codes to translate the entire input source into the target programming language.

8. The method of claim 1, wherein the prompt further includes a natural language directive that includes an instruction to translate the input program code from a source programming language to the target programming language.

9. The method of claim 1, further comprising performing sanitization, validation, and correction on the translation to ensure the translation is correct.

10. The method of claim 1, further comprising indexing a plurality of code samples in a plurality of programming languages, to generate respective metadata for each code sample, and storing the plurality of code samples with their respective metadata in the database.

11. A computer program product for code translation, the computer program product comprising a computer readable storage medium having program instructions embodied therewith, the program instructions executable by a hardware processor to cause the hardware processor to:
Generate metadata for input program code, including an intermediate representation of the input program code;
search a database of stored code samples to select an example code sample based on similarity between metadata of the input program code and stored metadata of the stored code samples;
generate a prompt that includes the input program code, the example code sample, and a translation of the example code sample; and
apply the prompt to a pre-trained language model to generate a translation of the input program code in a target programming language.

12. A system for code translation, comprising:
a hardware processor; and
a memory that stores a computer program which, when executed by the hardware processor, causes the hardware processor to:
generate metadata for input program code, including an intermediate representation of the input program code;
search a database of stored code samples to select an example code sample based on similarity between metadata of the input program code and stored metadata of the stored code samples;
generate a prompt that includes the input program code, the example code sample, and a translation of the example code sample; and
apply the prompt to a pre-trained language model to generate a translation of the input program code in a target programming language.

13. The system of claim 12, wherein generating the metadata further includes an abstract syntax tree of the input program code.

14. The system of claim 12, wherein generating the metadata further includes an embedding of the intermediate representation and a sparse encoding of the input program code.

15. The system of claim 12, wherein searching the database includes calculating a respective similarity score for each of a plurality of metadata types of the input program code as compared to corresponding metadata of stored code samples.

16. The system of claim 15, wherein searching the database includes performing a diversity re-ranking based on the similarity scores for the stored code samples to promote diversity between the stored code samples.

17. The system of claim 16, wherein searching the database comprises fusing rankings for the plurality of metadata types into a single rank score for each stored code sample.

18. The system of claim 17, further comprising performing a hammock decomposition on an input source into a plurality of program codes, of which the input program code is one, wherein generating metadata, searching the database, generating the prompt, and applying the prompt is performed for each of the program codes to translate the entire input source into the target programming language.

19. The system of claim 12, wherein the prompt further includes a natural language directive that includes an instruction to translate the input program code from a source programming language to the target programming language.

20. The system of claim 12, further comprising performing sanitization, validation, and correction on the translation to ensure the translation is correct.
